(19) United States
(12) Patent Application Publication
(10) Pub. No.: US 2024/0268574 A1
(43) Pub. Date: Aug. 15, 2024

(54) Popup Camper

(71) Applicant: Hardsider, Inc., Cincinnati, OH (US)

(72) Inventors: Noel Gauthier, Cincinnati, OH (US); Paul Eric Price, Cincinnati, OH (US); Randall Kent, Cincinnati, OH (US)

(73) Assignee: Hardsider, Inc., Cincinnati, OH (US)

(21) Appl. No.: 18/641,814

(22) Filed: Apr. 22, 2024

Related U.S. Application Data
(63) Continuation-in-part of application No. 18/386,033, filed on Nov. 1, 2023, now Pat. No. 11,988,006.
Application No. 18/386,033 is a continuation of application No. 18/084,725, filed on Dec. 20, 2022, now Pat. No. 11,840,857.

(51) Int. Cl. E04H 15/06; B32B 3/12; B32B 5/02; B32B 5/06; B32B 5/18; B32B 5/24; B60J 7/16; B60P 3/34; B60P 3/38; E04B 1/344

(52) U.S. Cl. CPC E04H 15/06; B32B 3/12; B32B 5/02; B32B 5/06; B32B 5/18; B32B 5/245; B60J 7/1621; B60P 3/341; B60P 3/38; E04B 1/3445; B32B 2250/05; B32B 2250/40; B32B 2250/44; B32B 2307/304; B32B 2605/00

(57) ABSTRACT

Disclosed is a mattress for a pop-up camper including a first mattress section, a first folding line, a second folding line, a second mattress section foldably connected to the first mattress section at the first folding line, and a third mattress section foldably connected to the first mattress section at the second folding line, where the first folding line and the second folding line are nonparallel.

This application is a continuation-in-part of U.S. patent application Ser. No. 18/386,033 filed Nov. 1, 2023 which is a continuation of U.S. patent application Ser. No. 18/084,725 filed Dec. 20, 2022, now U.S. Pat. No. 11,840,857, the entirety of the foregoing applications are hereby incorporated by reference.

### BACKGROUND OF THE INVENTION

### Field of the Invention

The embodiments of the invention relate to a folding mattress for a popup camper, and more particularly, to a mattress for a wedge style popup camper. Although embodiments of the invention are suitable for a wide scope of applications, it is particularly suitable for use in a camper having a low profile when in a folded position.

### Discussion of the Related Art

Popup campers of the related art include, generally, three-sided “wedge style” campers and four-sided “box style” campers. One such wedge style camper is disclosed in U.S. Pat. No. 11,130,437 of Tatro. The Tatro camper includes a top hingedly connected to the base, two triangular sidewalls, and a rectangular end wall opposite the hinge. The triangular sidewalls are substantially formed from two rigid panels having a central folding line such that the panels fold inwards when the top is hingedly rotated towards the based and straighten when the top is hingedly rotated away from the base. Once the top is fully rotated away from the base and the sidewalls fully erected, the end wall can be erected and attached to the top. The end wall is substantially formed from a single rigid panel and may have openings for doors or windows, See e.g., Tatro, FIG. 2E.

To collapse the related art wedge style campers, rigid sidewalls are generally folded inwards and stowed within a frame of the camper. The collapsed camper, however, must generally be of sufficient height to stow a mattress and the sidewalls between the top and base. The related art campers include tradeoffs with respect to the mattress to provide space to accommodate stowage of the sidewalls such as increasing the overall collapsed height, decreasing the thickness of the mattress, or requiring a user to stow the mattress in a different location than where it would normally be used.

Problems, however, exist in the related art in as much as multiple steps can be required to erect a wedge style camper. For example, after erecting the wedge style camper of the related art, the end wall needs to be separately erected. Because the end wall is large, it may be difficult to lean and reach to gain a sufficient hold on the end panel to rotate it into position. Additionally, after the end panel of the related art is in position, it then needs to be attached to the top and sidewalls. The attachment point of the end wall can be a point of weakness, repeated strain, and prospective failure. The awkward step of attaching the end wall required can take time, delaying deployment and stowage of the camper. A need exists for a popup camper that can be quickly deployed and stowed without having to separately attach and detach an end wall, where the camper is as thin and aerodynamic as possible while including a comfortable mattress.

### SUMMARY OF THE INVENTION

Accordingly, embodiments of the invention are directed to a popup camper that substantially obviates one or more of the problems due to limitations and disadvantages of the related art.

An object of embodiments of the invention is to provide a popup camper that can be erected without separately attaching sidewalls.

Another object of embodiments of the invention is to provide a popup camper that can be collapsed without separately detaching sidewalls.

Yet another object of embodiments of the invention is to provide a popup camper having hard sides.

Still another object of embodiments of the invention is to provide a mattress that stows easily for positioning a popup camper in a closed position.

Additional features and advantages of embodiments of the invention will be set forth in the description which follows, and in part will be apparent from the description, or may be learned by practice of embodiments of the invention. The objectives and other advantages of the embodiments of the invention will be realized and attained by the structure particularly pointed out in the written description and claims hereof as well as the appended drawings.

To achieve these and other advantages and in accordance with the purpose of embodiments of the invention, as embodied and broadly described, a mattress for a pop-up camper includes, a first mattress section, a first folding line, a second folding line, a second mattress section foldably connected to the first mattress section at the first folding line, and a third mattress section foldably connected to the first mattress section at the second folding line, where the first folding line and the second folding line are nonparallel.

In another aspect, a mattress can be configured to be disposed in a folded position and an unfolded position, and the mattress can include a sleeping surface, the sleeping surface having a top edge, a bottom edge, a first lateral edge, a second lateral edge, a third lateral edge adjacent the first lateral edge, and a fourth lateral edge adjacent the second lateral edge, where, in the unfolded position, the first lateral edge is parallel to the second lateral edge and the third lateral edge is nonparallel to the fourth lateral edge, and in the folded position, first lateral edge is nonparallel to the second lateral edge and the third lateral edge is adjacent the fourth lateral edge.

In yet another aspect, a folding mattress for a wedge-style pop-up camper, the camper having a hinged end and two inwardly folding sidewalls, the folding mattress can have a sleeping surface, a central mattress section, a first wing, a first foldable connection connecting the first wing to the central mattress section, a second wing, and a second foldable connection foldably connecting the second wing to the central mattress section, where the mattress can be disposed in a folded position wherein the first wing and second wing are folded onto the central mattress thereby creating space for the inwardly folding sidewalls.

It is to be understood that both the foregoing general description and the following detailed description are exemplary and explanatory and are intended to provide further explanation of embodiments of the invention as claimed.

### BRIEF DESCRIPTION OF THE DRAWINGS

The accompanying drawings, which are included to provide a further understanding of embodiments of the invention and are incorporated in and constitute a part of this specification, illustrate embodiments of the invention and together with the description serve to explain the principles of embodiments of the invention.

FIG. 1 is a perspective view of a popup camper in an open position according to an exemplary embodiment of the invention;

FIG. 2A and FIG. 2B are perspective views of a popup camper in an open position according to an exemplary embodiment of the invention;

FIG. 3A and FIG. 3B are perspective views of a popup camper in a partially opened position according to an exemplary embodiment of the invention;

FIG. 4 is a perspective view of a popup camper in a closed position according to an exemplary embodiment of the invention;

FIG. 5 is a cut away view of a sidewall of a popup camper according to an exemplary embodiment of the invention;

FIG. 6A and FIG. 6B are perspective views of a popup camper in an open position according to an exemplary embodiment of the invention;

FIG. 7A is a perspective view of a popup camper in an open position according to an exemplary embodiment of the invention;

FIG. 7B is a front elevation view of a popup camper in an open position according to an exemplary embodiment of the invention;

FIG. 7C is a left side view of a popup camper in an open position according to an exemplary embodiment of the invention;

FIG. 8 is a perspective view of a foldable mattress in an unfolded position;

FIG. 9 is a perspective view of a foldable mattress in a folded position; and

FIG. 10 is a perspective view of a foldable mattress in a folded position showing exemplary collapsed sidewalls of a pop-up camper.

### DETAILED DESCRIPTION OF THE PREFERRED EMBODIMENTS

Reference will now be made in detail to the preferred embodiments of the invention, examples of which are illustrated in the accompanying drawings. The invention may, however, be embodied in many different forms and should not be construed as being limited to the embodiments set forth herein; rather, these embodiments are provided so that this disclosure will be thorough and complete, and will fully convey the concept of the invention to those skilled in the art. In the drawings, the thicknesses of layers and regions are exaggerated for clarity. Like reference numerals in the drawings denote like elements.

Various of the figures show sidewalls of a popup camper assembled from one or more panels. Embodiments of the invention contemplate that the panels can be covered with a fabric material to retain and position the panels and to seal the camper from the weather. Similarly, embodiments of the invention contemplate a folding mattress comprising a plurality of mattress sections that are covered with fabric. In the figures, however, the fabric material has been variously omitted as not to obscure the relative size, position, and orientation of the panels and sections with respect to one another. Accordingly, the embodiments disclosed in the figures should not be construed to omit fabric layer(s).

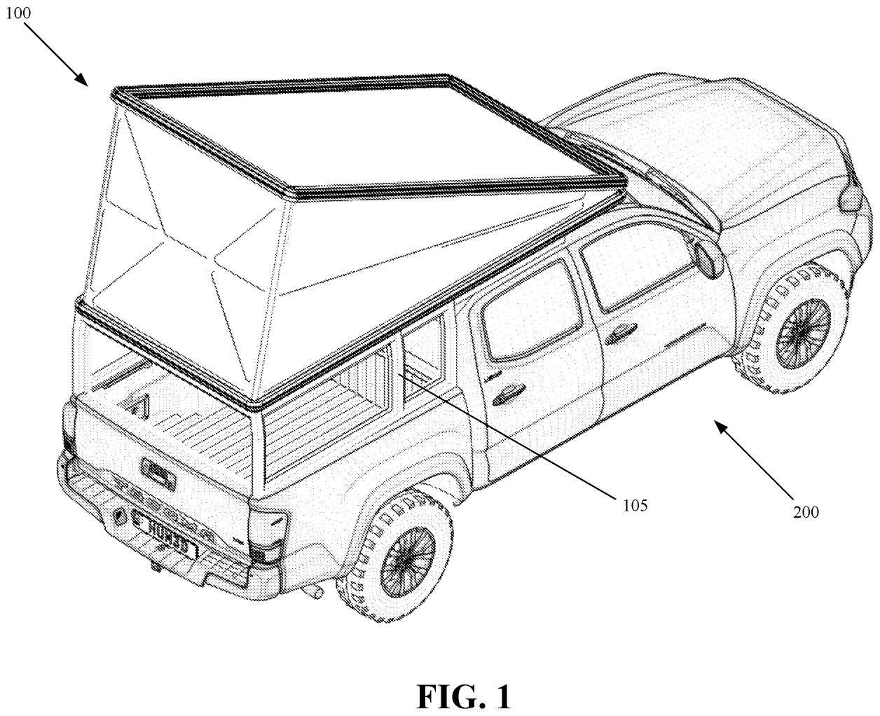

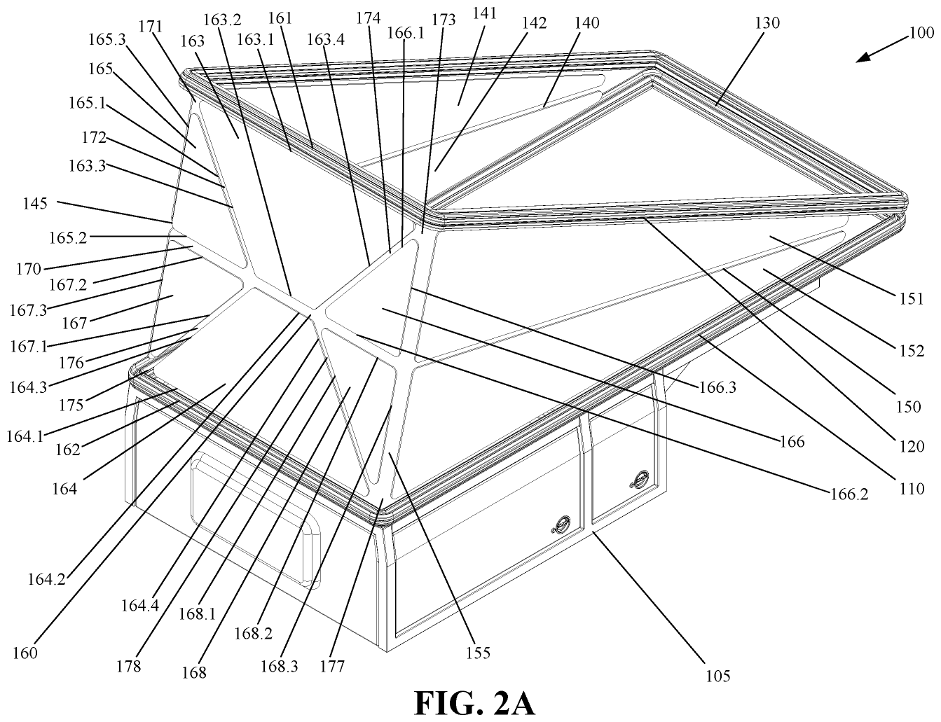

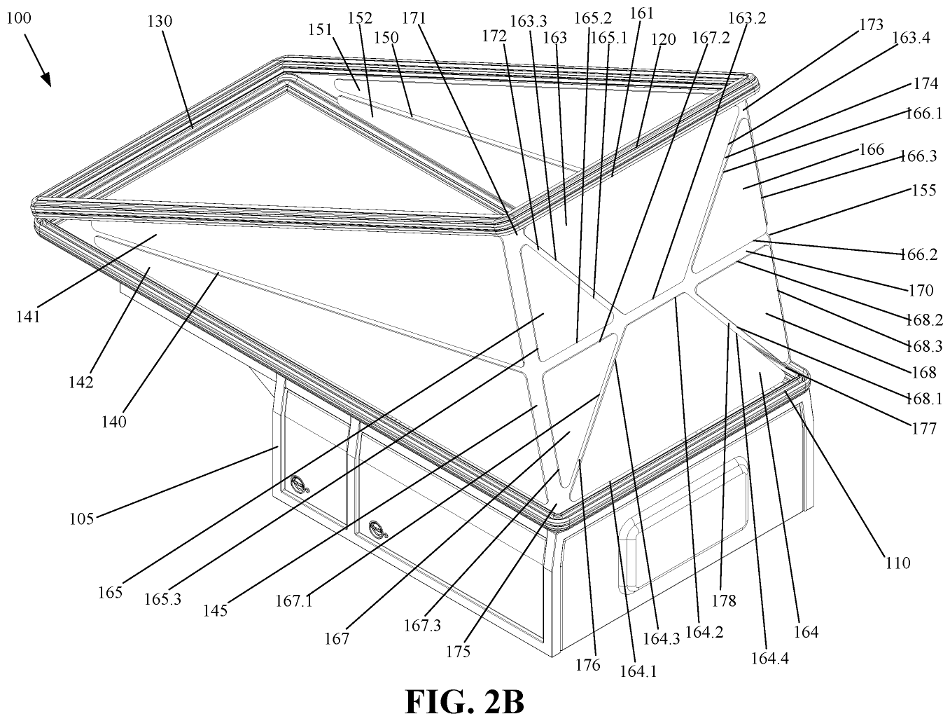

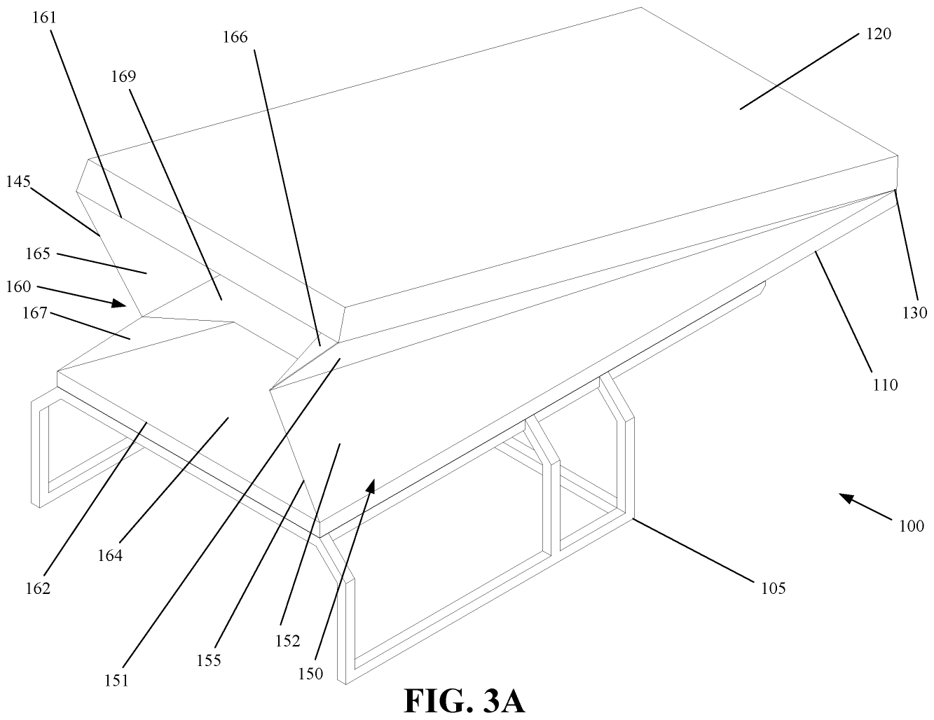

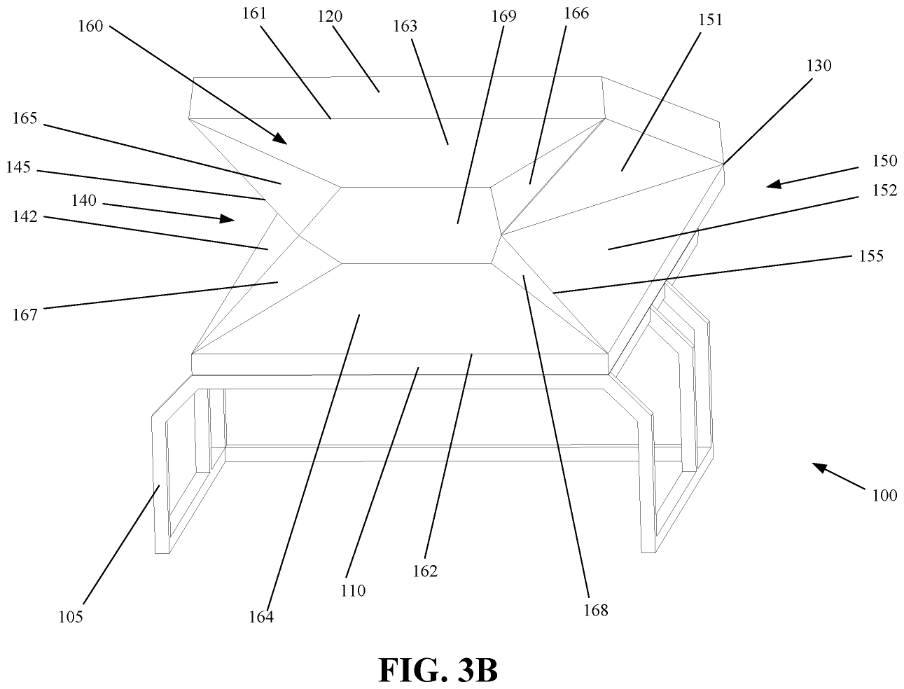

FIG. 1 is a perspective view of a popup camper in an open position according to an exemplary embodiment of the invention. As shown in FIG. 1, a popup camper 100 can be mounted on a frame 105. The frame 105 can be mounted over a bed of a pickup truck 200. In preferred embodiments of the invention, the popup camper 100 can extend over a cab of the pickup truck 200. As will be discussed in greater detail in conjunction with FIGS. 2A-3B, the sidewalls of the popup camper can be formed from one or more rigid panels. The top of the popup camper 100 can be hingedly a base such that the camper can be folded flat into a closed position for storage and travel and opened to an open position (as shown in FIG. 1) to enable use of an interior space.

FIG. 2A and FIG. 2B are perspective views of a popup camper in an open position according to an exemplary embodiment of the invention. As shown in FIG. 2A and FIG. 2B, a popup camper 100 can have a support frame 105, base 110, top 120, hinge 130, left side 140, right side 150, and end side 160. Base 110, top 120, left side 140, right side 150, and end side 160 can define an interior space (not labeled). Left side 140 can have panels 141 and 142. Right side 150 can have panels 151 and 152. End side 160 can have panels 163, 164, 165, 166, 167, and 168.

The left side 140 can be connected to the base 110, the top 120, and end side 160. The right side 150 can be connected to the base 110, the top 120, and end side 160. The end side 160 can be connected to the base 110, the top 120, left side 140, and right side 150. The left side 140 can be connected to end side 160 at edge 145. The right side 150 can be connected to end side 160 at edge 155. The end side 160 can be connected to the top 120 at edge 161. The end side 160 can be connected to the base 110 at edge 162. End side 160 can have corners 171, 173, 175, and 177.

Major folding line 170 can cross the end side 160. The major folding line 170 can substantially bisect end side 160 from edge 145 to edge 155 such that equal portions of the end side 160 are disposed above and below the major folding line 170. Minor folding lines 172, 174, 176, and 178 can extend from corners 171, 173, 175, and 177 (respectively) to the major folding line 170.

Panel 163 of end side 160 can have a trapezoid shape. A longest edge 163.1 of panel 163 can be adjacent top edge 161. Edge 163.2 of panel 163 can be adjacent major folding line 170. Edge 163.3 of panel 163 can be adjacent minor folding line 172. Edge 163.4 of panel 163 can be adjacent minor folding line 174.

Panel 164 of end side 160 can have a trapezoid shape. A longest edge 164.1 of panel 164 can be adjacent top edge 161. Edge 164.2 of panel 164 can be adjacent major folding line 170. Edge 164.3 of panel 164 can be adjacent minor folding line 176. Edge 164.4 of panel 164 can be adjacent minor folding line 178.

Panel 165 of end side 160 can have a triangle shape. A longest edge 165.1 can be adjacent minor folding line 172 and edge 163.3 of panel 163. Edge 165.2 can be adjacent edge major folding line 170 and panel 167. Edge 165.3 can be adjacent edge 145 and panel 141.

Panel 166 of end side 160 can have a triangle shape. A longest edge 166.1 can be adjacent minor folding line 174 and edge 163.4 of panel 163. Edge 166.2 can be adjacent edge major folding line 170 and panel 168. Edge 166.3 can be adjacent edge 155 and panel 151.

Panel 167 of end side 160 can have a triangle shape. A longest edge 167.1 can be adjacent minor folding line 176 and edge 164.3 of panel 164. Edge 167.2 can be adjacent edge major folding line 170 and edge 165.2 of panel 165. Edge 167.3 can be adjacent edge 145 and panel 152.

Panel 168 of end side 160 can have a triangle shape. A longest edge 168.1 can be adjacent minor folding line 178 and edge 164.4 of panel 164. Edge 168.2 can be adjacent edge major folding line 170 and edge 166.2 of panel 166. Edge 168.3 can be adjacent edge 145 and panel 152.

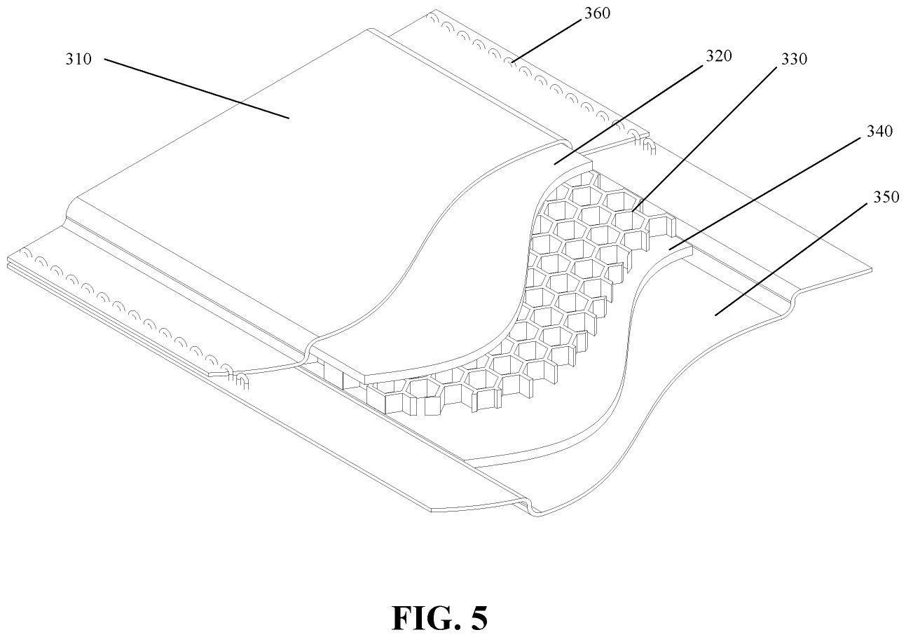

The panels and sides can be covered with fabric layers (not shown) to retain the panels in their relative positions and connect the sides and panels to the top 120 and bottom 130. The fabric layers are not shown in FIG. 2A and FIG. 2B to more clearly illustrate the relative position of panels. Although it may appear that the panels of FIG. 2A and FIG. 2B are disconnected, they can be interconnected via fabric layers. Fabric layers as will be discussed in greater detail in conjunction with FIG. 5. In FIG. 2A and FIG. 2B, top 120 is shown as open or transparent for clarity. In preferred embodiments, top 120 can be formed from fabric layers or one or more rigid panels. In FIG. 2A and FIG. 2B, base 110 has been illustrated as a continuous platform for clarity. In preferred embodiments, the base 110 can have varying configurations of access panels or open portions to facilitate human movement between a bed of a truck and the popup camper 100.

Base 110 can be connected to top 120 via hinge 130. Hinge 130 can be formed from fabric layers connected to base 110 and top 120. Hinge 130 can be formed from other types of mechanical hinges known to those of skill in the art and covered with a fabric layer for weather sealing.

The popup camper 100 of FIG. 2A and FIG. 2B is illustrated in an open position where the top 120 is hingedly rotated away from the base 110 so that sidewalls 140, 150, and 160 are fully extended. The popup camper can alternatively be disposed in a closed position where the top 120 is hingedly rotated towards the base 110 and the sidewalls 140, 150, and 160 fold inwards. The end side 160 can be permanently connected to edges 145, 155, 161, and 162. In transitioning the popup camper 100 from an open position to a closed position, the end side 160 can remain connected to edges 145, 155, 161, and 162. The novel shape and configuration of panels in sides 140, 150, and 160 allow the popup camper 100 to transition from an open position to a closed position and back to an open position without disconnecting sides from any edges. This represents an improvement over the related art where traditionally (1) at least one side had to be erected or attached after the camper was opened and subsequently detached before collapsing the camper; or (2) at least one side was formed entirely from fabric. In contrast, in the present invention, all sides can be formed from one or more rigid panels and no sides must be attached or detached during assembly or break down. Rigid panels can be superior to fabric-only panels because rigid panels can have superior insulating properties, superior noise attenuation properties, provide superior security, and can present a neater, cleaner appearance.

As will be described in greater detail in conjunction with FIG. 5, sides 140, 150, and 160 can be formed substantially from one or more rigid panels disposed between fabric layers. The panels can be partially or completely retained in their relative positions between the fabric layers by a retention mechanism such as stitching, rivets, adhesive, Velcro, snaps, buttons, or methods as would be apparent to one of skill in the art for coupling rigid panels to fabric.

In preferred embodiments of the invention, the panels can “float” between fabric layers in as much as the panels are minimally retained in their relative position with a retention mechanism or entirely unrestrained by a retention mechanism. When a panel floats it can be substantially retained in its relative position by the edges of the corresponding side wall and the other panels of the side wall. The fabric layers can be formed from a pliable fabric that can stretch in one or more dimensions. The fabric layers can be formed from a blend of synthetic materials such as nylon or rayon and elastic materials such as rubber or spandex. In combination, the stretchability of the fabric layers, the spaces between the panels, and the floating nature of the panels can facilitate easy transition between an open position and a closed position. As will be discussed in greater detail in conjunction with FIG. 3A and FIG. 3B, space 169 can form between the panels of end wall 160 when the camper is transitioned between an open position and a closed position.

In transitioning between an open position and a closed position, sidewall 150 can fold inwards such that exterior faces of panels 151 and 152 are adjacent to one another. Sidewall 140 can fold inwards such that exterior faces of panels 141 and 142 are adjacent to one another. End wall 160 can fold inwards (as shown in transition view FIG. 3A and FIG. 3B) such that: exterior faces of panels 163, 165, and 166 are adjacent; exterior faces of panels 164, 167, and 168 are adjacent; exterior faces of panels 163 and 164 are adjacent; interior faces of panels 165 and 167 are adjacent; and interior faces of panels 166 and 168 are adjacent.

As used herein, the term adjacent can mean in substantial proximity or next to. Edges of a panel or a side can be adjacent when they are next to another edge even though they may be separated by a small distance or connected via an intermediary structure such as fabric. Faces of a panel or side can be adjacent when they are next to another face even though they may be separated by a small distance or partially separated by an intermediary structure such as another panel. In a closed position, exterior faces of panels 163 and 164 are considered to be adjacent even though panels 163 and 164 may be separated in a sandwich arrangement by panels 165 and 167 on one side and panels 166 and 168 on another side. Similarly, in a closed position, interior faces of panels 165 and 167 are considered to adjacent even though they may be separated in a sandwich arrangement by panels 141 and 142. In another example, in an open position, edge 163.3 of panel 163 can be considered adjacent to edge 165.1 of panel 165 even though they are illustrated as not touching.

Embodiments of the invention disclose major folding lines and minor folding lines. A folding line, whether major or minor, can be an area where the sides of a popup camper are configured to fold. Major folding line 170 can bisect end side 160. Three or more panels can have an edge on major folding line 170. Minor folding lines 172, 174, 176, and 178 can separate two or more panels and can intersect of connect to a major folding line. Although major folding lines and minor folding lines have been disclosed and described in conjunction with the foregoing embodiment, the terms should not be construed as limited to the embodiment. Indeed, a popup camper may have two or more major folding lines that share an edge with varying number of panels and a popup camper may have minor folding lines in varying numbers and sharing edges with varying number of panels.

FIG. 3A and FIG. 3B are perspective views of a popup camper in a partially opened position according to an exemplary embodiment of the invention. The illustrations of FIG. 3A and FIG. 3B have been simplified over those shown in FIG. 2A and FIG. 2B to illustrate the manner in which a popup camper can fold. In this regard panels have been illustrated in a general sense without precise regard to the spaces between them and the fabric layers that cover them and accordingly, is not intended to limit the scope of the invention. As shown in FIG. 3A and FIG. 3B, a popup camper in a transition between an open and a closed position can have a support frame 105, base 110, top 120, hinge 130, left side 140, right side 150, and end side 160. Base 110, top 120, left side 140, right side 150, and end side 160 can define an interior space (not labeled). Left side 140 can have two panels: panel 142 and panel 141 (not shown; see FIG. 2B). Right side 150 can have panels 151 and 152. End side 160 can have panels 163, 164, 165, 166, 167, and 168.

The left side 140 can be connected to the base 110, the top 120, and end side 160. The right side 150 can be connected to the base 110, the top 120, and end side 160. The end side 160 can be connected to the base 110, the top 120, left side 140, and right side 150. The left side 140 can be connected to end side 160 at edge 145. The right side 150 can be connected to end side 160 at edge 155. The end side 160 can be connected to the top 120 at edge 161. The end side 160 can be connected to the base 110 at edge 162.

When transitioning from an open position to a closed position, sides 140 and 150 can fold inwards. As sides 140 and 150 fold inwards, end side 160 can collapse and fold inwards. As the popup camper is collapsed, panels 165, 166, 167, and 168 of end side 160 can have compound movement with respect to their positions shown in FIG. 2A and FIG. 2B. For example, panel 165 can rotate counter clockwise with respect to end side 160 (as shown in FIG. 3B) to facilitate folding of left side 140 and can also rotate inwards to facilitate folding of end side 160. Panels 166, 167, and 168 can have similar movement. To further facilitate fluid folding some “play” in the system can be advantageous. In preferred embodiments of the invention panels of walls can float between fabric layers and fabric layers can be formed from stretchy material. In the embodiment illustrated in FIG. 3A and FIG. 3B, gap 169 can form when the camper is transitioned between and open and closed position. Although gap 169 is illustrated as central to 163, 164, 165, 166, 167, and 168, the illustration of gap 169 is intended to approximate the relative movement of floating panels while transitioning between open and closed positions. In commercial embodiments, gap 169 may manifest in other locations or many locations depending on the geometry of the panels, attachments (if any) of the panels to any other structures, and other forces acting upon the system. In general, however, floating allows binding forces between panels to be relieved at the point of prospective binding rather than preventing the system from folding or causing damage to the rigid panels. Although gap 169 is illustrated as a visible gap, the panels in preferred embodiments of the invention can be covered in fabric and the gap 169 can be obscured from view. Then the popup camper is fully collapsed, the gap 169 can be substantially closed relieving stretching forces on the fabric layers.

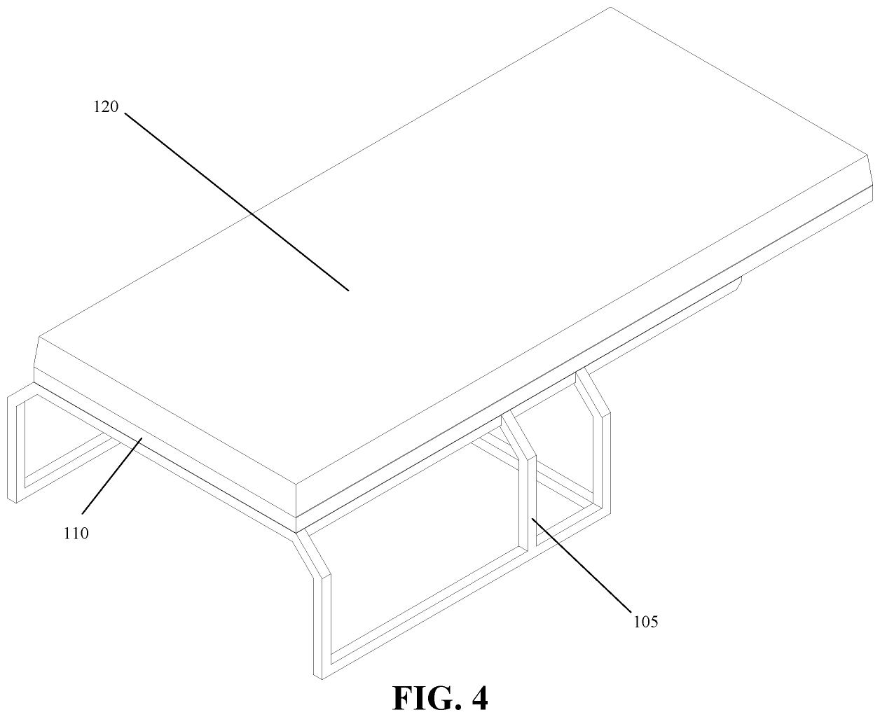

FIG. 4 is a perspective view of a popup camper in a closed position according to an exemplary embodiment of the invention. As shown in FIG. 4, in a closed position, the top 120 of the popup camper can be adjacent the bottom 110. A base frame 105 can support the base 110. The base frame 105 can be sized in relative proportions to match the size of a bed of a particular pickup truck. In the closed as shown in FIG. 4, the panels of sidewalls can be neatly folded inwards. In the closed position and with reference to FIG. 2A and FIG. 2B, sidewall 150 can fold inwards such that exterior faces of panels 151 and 152 are adjacent to one another. Sidewall 140 can fold inwards such that exterior faces of panels 141 and 142 are adjacent to one another. End wall 160 can fold inwards (as shown in transition view FIG. 3A and FIG. 3B) such that: exterior faces of panels 163, 165, and 166 are adjacent; exterior faces of panels 164, 167, and 168 are adjacent; exterior faces of panels 163 and 164 are adjacent; interior faces of panels 165 and 167 are adjacent; and interior faces of panels 166 and 168 are adjacent. The popup camper can be maintained in an open or closed position with a gas strut or spring (not shown).

FIG. 5 is a cut away view of a sidewall of a popup camper according to an exemplary embodiment of the invention. As shown in FIG. 5, a side wall can be formed substantially as a sandwich of a fabric layer 310, a foam layer 320, an insulating layer 330, a foam layer 340, and a fabric layer 350. Stitching 360 can connect fabric layer 310 to fabric layer 350. In preferred embodiments of the invention, stitching 360 does not directly penetrate layers 330, 340, or 350 allowing these intermediate layers to float between fabric layers 310 and 350.

Fabric layers 310 and 350 can preferably be formed from a blend of synthetic fabric that is durable yet pliable with some stretching properties. The fabric layers can be formed from a blend of synthetic materials such as nylon or rayon and elastic materials such as rubber or spandex. Foam layers 320 and 340 can be formed from rigid or semi-rigid closed cell foam. Rigid or semi-rigid foam can provide sound dampening, insulation, and give structure to side walls. Insulating layer 330 can be formed from plastic, silicone, or open cell foam. Insulating layer 330 can be rigid, semi-rigid, or generally flexible. Insulating layer 330 have airspace within to trap air and provide insulating properties. Foam layers 320 and 340 can be attached to insulating layer 330 with adhesives or other methods of attachment known in the art. In preferred embodiments, foam layers 320 and 340 are semi-rigid closed cell foam and insulating layer is injection molded plastic.

Although FIG. 5 is illustrated as having a single panel (formed from layers 320, 330, and 340) between fabric layers 310 and 350, the invention contemplates that two or more panels can be disposed between fabric layers. Edges of panels between fabric layers can loosely touch or be adjacent without a rigid connection. When a popup camper is opened or closed, the panels can move slightly between the fabric layers to relieve stress and intermittent binding forces. Depending on the thickness of panels and the number of panels, the panels may have minimal rigid or non rigid connections to the fabric layers to maintain the panels in their relative positions. On one embodiment, one edge of a panel can be attached to an edge of a sidewall while the other edges float. The attachment can be a rigid attachment such as stitching, screws, or a metal hinge, or a semi rigid attachment such as an elastic or fabric connector. This minimal attachment can ensure that panels remain in their relative positions while still allowing them to substantially float between fabric layers.

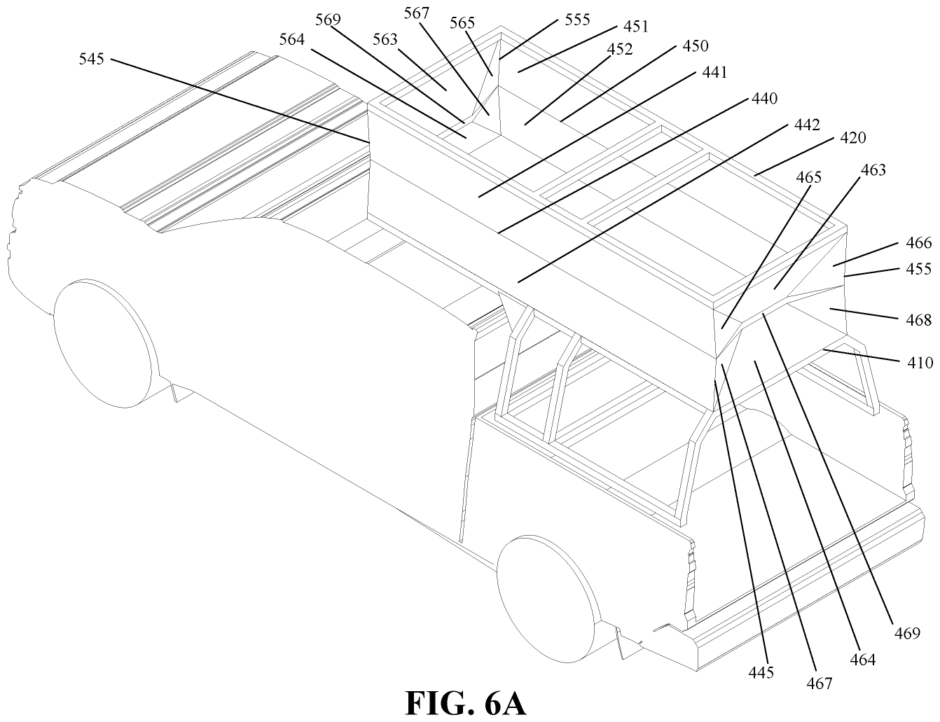

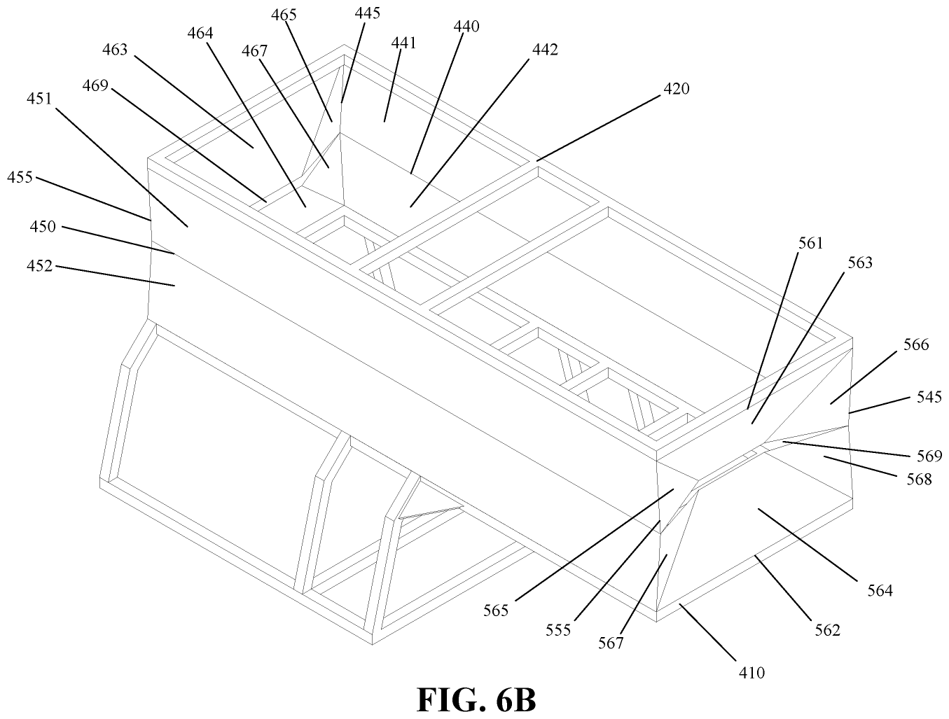

FIG. 6A and FIG. 6B are perspective views of a popup camper in an open position according to an exemplary embodiment of the invention. The embodiment of FIG. 6A and FIG. 6B is similar to that of FIG. 2A and FIG. 2B except that the popup camper of FIG. 6A and FIG. 6B is four-sided rather than the three-sided embodiment of FIG. 2A and FIG. 2B. As shown in FIG. 6A and FIG. 6B, a pop-up camper can have a base 410, a top 420, a left side 440, and a right side 450. An end side can have panels 463, 464, 465, 466, 467, and 468. An opposite end side can have panels 563, 564, 565, 566, 567, and 568. Left side can have edges 445 and 545 connected to end sides. Right side can have edges 555 and 455 connected to end sides.

Panels 451 and 452 of right side and panels 441 and 442 of left side can be rectangular whereas in the embodiment of FIG. 2A and FIG. 2B the analogous panels were triangular. When in an open position rectangular panels 451, 452, 441, and 442 can cause the opposite end to expand where, in contrast to FIG. 2A and FIG. 2B, a hinge 130 connected the base to the top.

Panels of end sides can have analogous function to panels 163, 164, 165, 166, 167, and 168 described in conjunction with FIG. 2A-3B. With reference to FIG. 6B, a longest side of panel 563 can be adjacent to top edge 561 of top 420. A longest side of panel 563 can be adjacent to a bottom edge 562 of bottom 410. Panel 565 can be adjacent edge 555, panel 563, and panel 567. Panel 566 can be adjacent edge 545, panel 563, and panel 568. Panel 567 can be adjacent edge 555, panel 564, and panel 565. Panel 568 can be adjacent edge 545, panel 564, and panel 566.

In transitioning between an open position (shown in FIGS. 6A and 6B) to a closed position, end wall panels 463, 464, 465, 466, 467, and 468 and end wall panels 563, 564, 565, 566, 567, and 568 can have analogous function to panels 163, 164, 165, 166, 167, and 168 (respectively) described in conjunction with FIG. 2A-3B. Gaps 469 and 569 can have analogous function to gap 169 described in conjunction with FIG. 2A-3B.

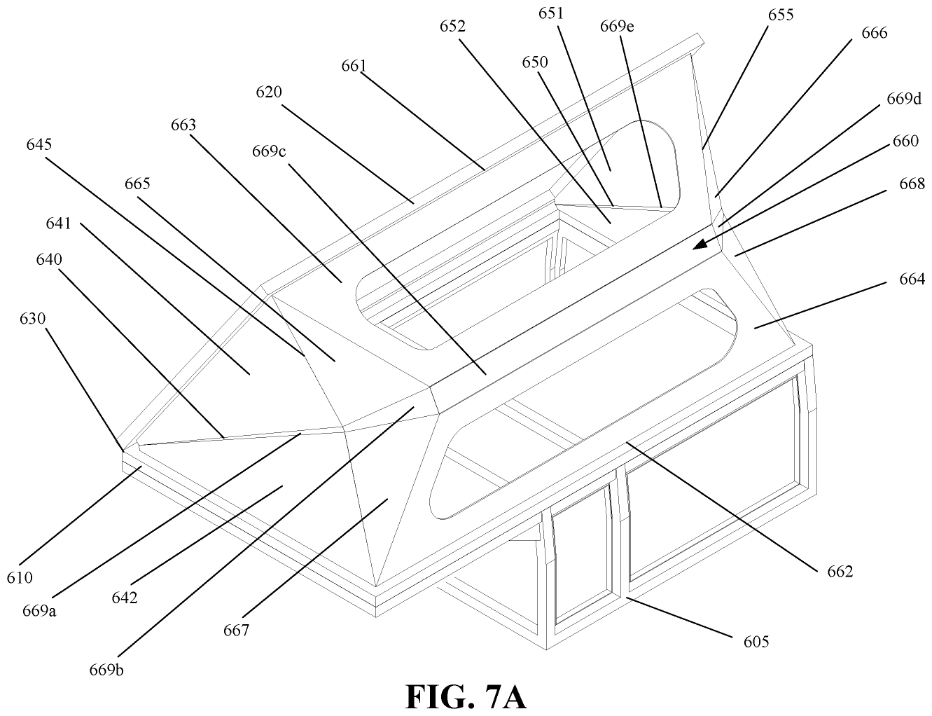

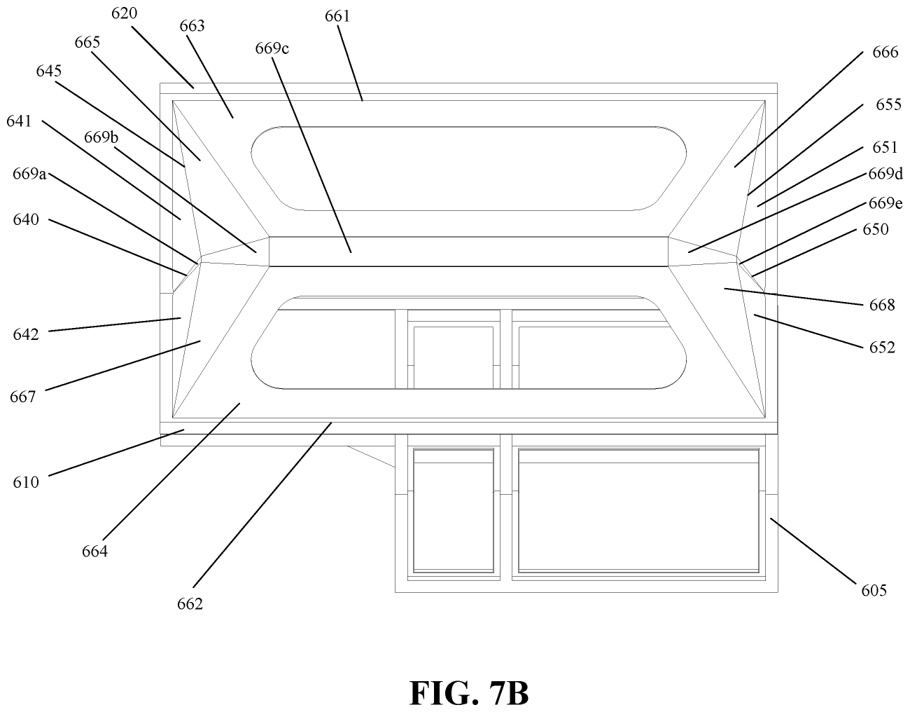

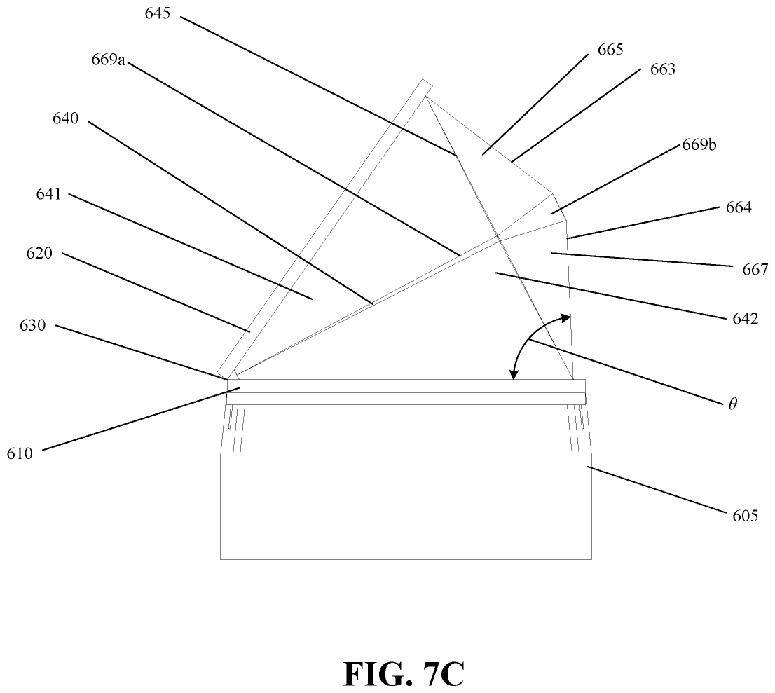

FIG. 7A is a perspective view of a popup camper in an open position according to an exemplary embodiment of the invention, FIG. 7B is a front elevation view of a popup camper in an open position according to an exemplary embodiment of the invention, and FIG. 7C is a left side view of a popup camper in an open position according to an exemplary embodiment of the invention. The embodiment of FIG. 7A-7C is analogous to the embodiment described in conjunction with FIG. 2A-3B except that the popup camper is hinged on a side rather than on an end and the panels can be slightly oversized in comparison to space formed between the base and top in the open position. Hinging on a wide side, rather than a narrow end, can increase the total amount of high head space increasing comfort for users. Similarly, oversized panels can cause a long side to bulge outwards further increasing internal space.

As shown in FIG. 7A, FIG. 7B, and FIG. 7C, a popup camper can include support frame 605, a base 610, a top 620, hinge 630, left side wall 640, right side wall 650, and end wall 660. Left side wall 640 can have panels 641 and 642 and edge 645. Right side wall 650 can have panels 651 and 652 and edge 655. End wall 660 can have edges 661 and 662 and panels 663, 664, 665, 666, 667 and 668. Gaps 669a-669e can relieve binding forces between panels and smooth operation of the pop-up camper.

Left side wall 640 can be attached to top 610 and base 620 and end wall 660 at edge 645. Right side wall 650 can be attached to top 610 and base 620 and end wall 660 at edge 655. End wall 660 can be connected to right side wall 650 at edge 655, left side wall 640 at edge 645, top at edge 661, and bottom at edge 662.

Panels 641 and 642 of left side wall 640 can be slightly larger than necessary to fill the space between base 610 and top 620 in the open position. Panels 651 and 652 of right side wall 650 can be slightly larger than necessary to fill the space between base 610 and top 620. In preferred embodiments of the invention, the left side wall 640 and right side wall 650 are slightly pinched inwards (as shown in FIG. 7B) to account for the slightly oversized panels.

Oversized side panels 641, 642, 651, and 652 can have cascading, unexpected benefits on panels 663, 664, 665, 666, 667 and 668. For example, by pinching in panel 642 the angle of edge 645 is altered and pushes panel 667 downwards and outwards. This in turn pushes panel 664 even further outwards and increases gaps 669b-669d. As shown in FIG. 7C, the pinching in of panel 642 has caused a bulge in end wall 660 and pushed panel 667 to angle θ. Angle θ is preferably at least 75 degrees and preferably about 90 degrees. This further increases usable space inside the popup camper and increases the comfort of that space.

When compared to an end-hinging popup camper such as disclosed in FIGS. 2A-3B, a side-hinging popup camper such as disclosed in FIG. 6A-6B can have more internal space and more headroom where one of the longest wall 664 is substantially vertical with respect to the base thereby maximizing usable space. Where a popup camper is approximately the dimensions of the bed of a pickup truck, the popup camper of FIGS. 2A-3B allows substantially one person to sit upright near the narrow end wall 160 and perhaps two people depending on how closely they are willing to share space. In contrast, the popup camper of FIG. 6A-6B has an end wall that is substantially the length of the bed of the pickup and allows two or more people to comfortably sit upright against end wall 660.

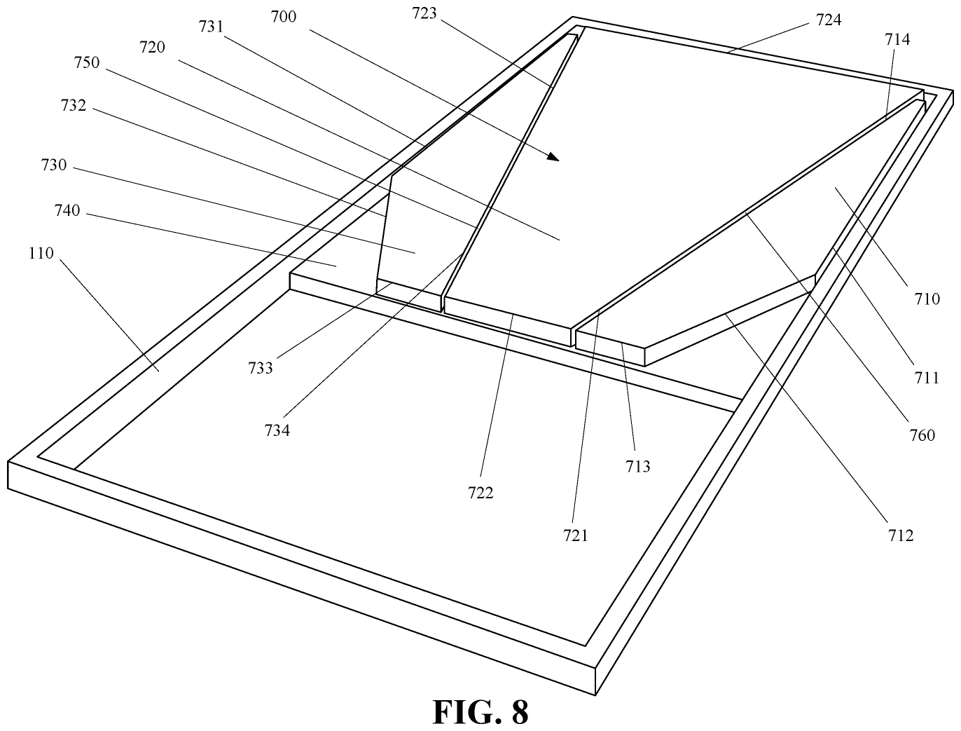

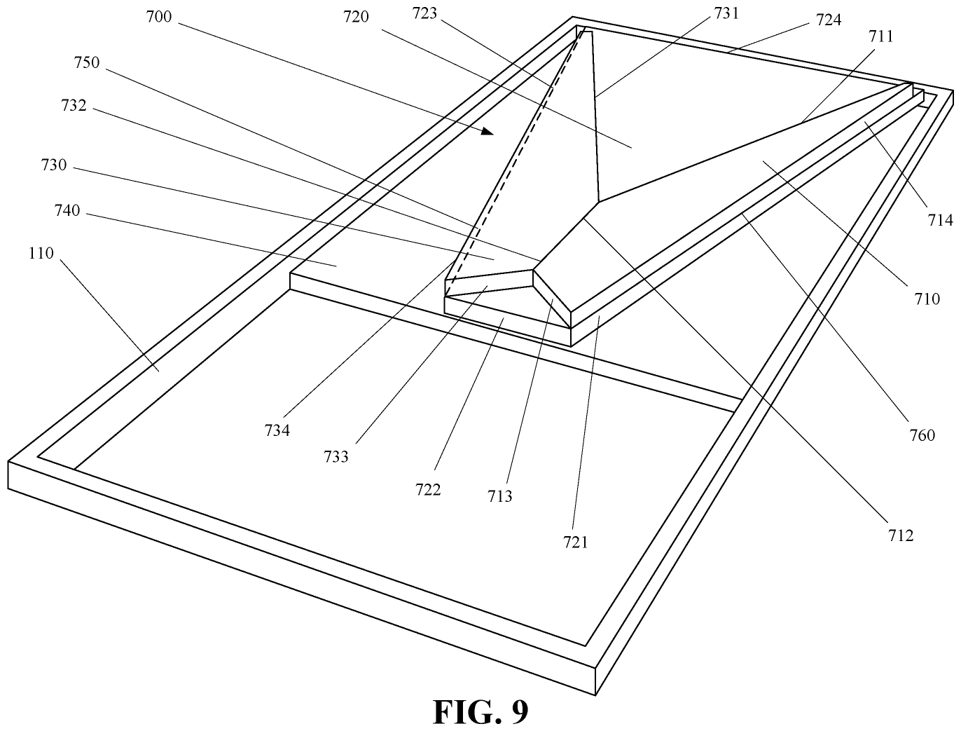

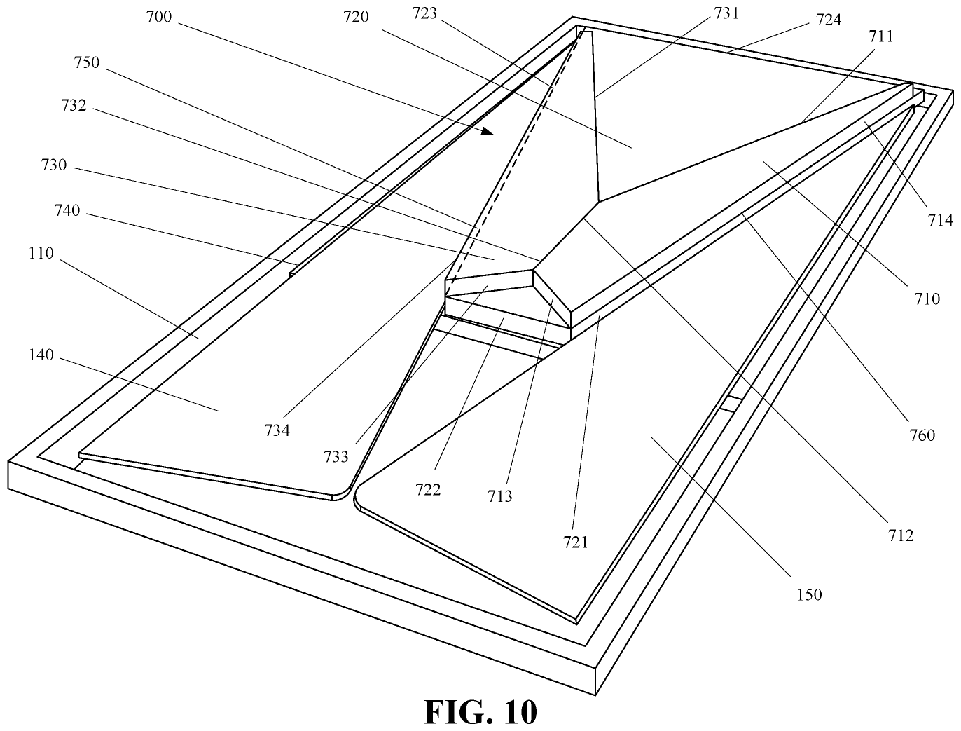

FIG. 8 is a perspective view of a foldable mattress in an unfolded position, FIG. 9 is a perspective view of a foldable mattress in a folded position, and FIG. 10 is a perspective view of a foldable mattress in a folded position showing exemplary collapsed sidewalls of a pop-up camper. As shown in FIG. 8, FIG. 9, and FIG. 10, a foldable mattress 700 can be sized in approximate proportions to fit within a base 110 of a popup camper. The foldable mattress 700 can include a middle section 720 and two side sections (“wings”) 710 and 730. The middle section can have a top edge 724, bottom edge 722, and side edges 721 and 723. Side section 710 can have bottom edge 713, edge 714, and lateral edges 711 and 712. Side section 730 can have bottom edge 733, edge 734, and lateral edges 731 and 732. The folding mattress 700 can have a top surface (generally shown in FIG. 8) for sleeping. An underlayment 740 can support the mattress within the base 110.

Middle section 720 can be connected to side section 710 at edges 721 and 714, respectively, forming folding line 760. Middle section 720 can be connected to side section 730 at edges 723 and 734, respectively, forming folding line 750. In preferred embodiments of the invention each of the mattress sections can be covered with fabric (not shown for clarity). The mattress sections 710, 720, and 730 can be connected using existing methods of textile joinery known in the art. In one example, edges 721 and 714 and edges 723 and 734 can be sewn together to connect the respective mattress sections. In another example, a top fabric layer can overlay all mattress sections and be sewn to each of the mattress sections thereby joining the mattress sections. In each of the foregoing examples, the joining of the mattress sections can create a fabric hinge that foldably connects the mattress sections. The mattress sections are preferably connected at their top edges so that the side sections 710 and 730 can easily fold onto middle section 720 as shown in FIG. 9 and FIG. 10.

The folding mattress 700 can be disposed in an unfolded position as shown in FIG. 8. The folding mattress 700 and alternatively be disposed in a folded position as shown in FIG. 9 and FIG. 10. In the unfolded position of FIG. 8, side sections 710 and 730 can be folded away from middle section 720 to expand useable area of the folding mattress 700. The unfolded position can be advantageously used for sleeping. In the folded position of FIG. 9, side sections 710 and 730 can be folded on top of middle section 720 creating empty space on either side of the middle section 720. As shown in FIG. 10, sidewalls 140 and 150 can be disposed in the space formerly occupied by the folding mattress when a camper is in a collapsed or folded position. In this way, the height of the popup camper can be reduced when it is in the folded or collapsed position providing a thinner, less bulky, and more aerodynamic camper.

The foldable mattress 700 can have folding line 750 and 760. Folding lines 750 and 760 can be disposed on a longest edge of side sections 710 and 730 and side edges 723 and 721 of middle section 720. Folding lines 750 and 760 are preferably nonparallel. Folding lines 750 and 760 can have an equal length. Middle section 720 can have a trapezoid shape. Side edge 723 and 721 of middle section 720 can have an equal length and the middle section 720 can be an isosceles trapezoid.

Top edge 724 and bottom edge 722 of middle section 720 can be parallel. Edges 733, 722, and 713 can be colinear and or parallel when the mattress 700 is in an unfolded position. Edges 733, 722, and 713 can be nonlinear and or nonparallel when the mattress is in the folded position. Mattress sections 710, 720, and 730 can be nonrectangular. Mattress sections 710, 720, and 730 can be quadrilaterals. Side mattress sections 710 and 730 can be pentagon-shaped. Side mattress sections 710 and 730 can have an irregular quadrilateral shape. Side mattress sections 710 and 730 can be congruent. Side mattress sections 710 and 730 can have a same shape. Side mattress sections 710 and 730 can be congruent. Side mattress sections 710 and 730 can have a different shape than middle section 720.

Side mattress section 710 can have lateral edge 711 and lateral edge 712. Side mattress section 730 can have lateral edge 731 and lateral edge 732. In an unfolded position, lateral edges 711 and 731 can be parallel. In a folded position, lateral edges 711 and 731 can be nonparallel. In an unfolded position, lateral edges 732 and 712 can be nonparallel. In a folded position, lateral edges 732 and 712 can be parallel. In a folded position, lateral edges 732 and 712 can be adjacent.

While most mattresses of the related art are rectangular quadrilaterals, the folding mattress 700 can be a nonquadrilateral. In preferred embodiments, folding mattress 700 can have six sides.

It will be apparent to those skilled in the art that various modifications and variations can be made in the popup camper without departing from the spirit or scope of the invention. Thus, it is intended that embodiments of the invention cover the modifications and variations of this invention provided they come within the scope of the appended claims and their equivalents.

What is claimed is:

1. A mattress for a pop-up camper comprising:
a first mattress section;
a first folding line;
a second folding line;
a second mattress section foldably connected to the first mattress section at the first folding line;
a third mattress section foldably connected to the first mattress section at the second folding line; and
wherein the first folding line and the second folding line are nonparallel.

2. The mattress for a pop-up camper of claim 1 wherein the first, second, and third mattress sections are nonrectangular.

3. The mattress for a pop-up camper of claim 1 wherein the first mattress section is trapezoid-shaped.

4. The mattress for a pop-up camper of claim 1 wherein the second mattress section is pentagon-shaped.

5. The mattress for a pop-up camper of claim 1 wherein the second mattress section is a congruent to the third mattress section.

6. The mattress for a pop-up camper of claim 1 wherein the first folding line and the second folding line are a same length.

7. The mattress for a pop-up camper of claim 1 wherein the first folding line is on a longest edge of the second mattress section.

8. The mattress for a pop-up camper of claim 1 further comprising:
a bottom edge of the first mattress section;
a bottom edge of the second mattress section;
a bottom edge of the third mattress section;
wherein the mattress is configured to be disposed in a folded position and an unfolded position;
wherein in the unfolded position, the bottom edges of the first, second, and third mattress sections are linear;
wherein in the folded position, the bottom edges of the first, second, and third mattress sections are nonlinear;

9. A mattress for a pop-up camper configured to be disposed in a folded position and an unfolded position, the mattress comprising:
a sleeping surface, the sleeping surface having
a top edge;
a bottom edge;
a first lateral edge;
a second lateral edge;
a third lateral edge adjacent the first lateral edge;
a fourth lateral edge adjacent the second lateral edge;
wherein in the unfolded position, the first lateral edge is parallel to the second lateral edge and the third lateral edge is nonparallel to the fourth lateral edge; and
wherein in the folded position, first lateral edge is nonparallel to the second lateral edge and the third lateral edge is adjacent the fourth lateral edge.

10. The mattress for a pop-up camper of claim 9 further comprising:
a first folding line extending from the top edge to the bottom edge;
a second folding line extending from the top edge to the bottom edge;
a first mattress section;
a second mattress section connected to the first mattress section at the first folding line;
a third mattress section connected to the first mattress section at the second folding line;

11. The mattress for a pop-up camper of claim 10 wherein the first folding line and the second folding line are nonparallel

12. The mattress for a pop-up camper of claim 10 wherein the first mattress section is a nonrectangular-shape.

13. The mattress for a pop-up camper of claim 10 wherein the first mattress section is a trapezoid-shape.

14. The mattress for a pop-up camper of claim 9 wherein the mattress is a nonquadrilateral-shape.

15. The mattress for a pop-up camper of claim 9 wherein the third lateral edge and first lateral edge are nonparallel and the fourth lateral edge and second lateral edge are nonparallel.

16. A folding mattress for a wedge-style pop-up camper, the camper having a hinged end and two inwardly folding sidewalls, the folding mattress comprising:
a sleeping surface;
a central mattress section;
a first wing;
a first foldable connection connecting the first wing to the central mattress section;
a second wing;
a second foldable connection connecting the second wing to the central mattress section; and
wherein the mattress can be disposed in a folded position wherein the first wing and second wing are folded onto the central mattress thereby creating space for the inwardly folding sidewalls.

17. The folding mattress of claim 16 further comprising:
a first folding line defined by the first foldable connection;
a second folding line defined by the second foldable connection; and
wherein the first folding line and the second folding line are nonparallel.

18. The folding mattress of claim 16 further comprising:
a bottom edge of the central mattress section;
a bottom edge of the first wing;
a bottom edge of the second wing; and
wherein, in the folded position, the bottom edges are nonlinear and wherein, in an unfolded position, the top edges are linear.

19. The folding mattress of claim 16 further comprising:
a side edge of the first wing;
a side edge of the second wing; and
wherein, in the folded position, the side edges are nonparallel.

20. The folding mattress of claim 16 wherein the central mattress section has an isosceles trapezoid-shape.
